(19) United States
(12) Patent Application Publication
(10) Pub. No.: US 2017/0363420 A1
(43) Pub. Date: Dec. 21, 2017

(54) LASER BEAM PATH OF LASER DISTANCE MEASURE

(71) Applicant: PRECASTER ENTERPRISES CO., LTD., TAICHUNG CITY (TW)

(72) Inventor: Nen-Tsua Li, TAICHUNG CITY (TW)

(21) Appl. No.: 15/183,799

(22) Filed: Jun. 16, 2016

(51) Int. Cl. G01C 3/08; G01S 17/08; G01S 7/481

(52) U.S. Cl. CPC G01C 3/08; G01S 7/4817; G01S 17/08

(57) ABSTRACT

A laser beam path device received in a laser distance measure includes a box having a receiving unit and a first reflector respectively in two ends of the box. The first reflector is inclinedly installed and has a hole defined centrally therethrough. The receiving unit controls displacement of the laser distance measure. A driving unit is located above the first reflector and has a second reflector received therein which is located corresponding to the first reflector. An opening is defined through the driving unit and located corresponding to the second reflector. A laser unit is connected to the box and emits laser beams which pass through the hole of the first reflector and are reflected by the second reflector, and the laser beams move toward an object. The laser beam are bounced back by the object and reflected by first and second reflectors, and received by the receiving unit.

### BACKGROUND OF THE INVENTION

### 1. Fields of the Invention

The present invention relates to a laser distance measure, and more particularly, to a laser beam path of laser distance measures so as to precisely control movement of the device cooperated with the laser distance measure.

### 2. Descriptions of Related Art

The conventional laser distance measures are used for measure distance from the laser beam source to an object, and the widely used movable vacuum cleaners are cooperated with a laser distance measure to measure the distance from the cleaner to a fixed object so as to control the movement of the cleaner and not to hit the object hard. Some plants are equipped with carts which use the laser distance measures to move goods without need of labors.

Most of the travel routes are fixed and pre-programmed in the cleaners or carts, once objects are moved, the users have to set the route of the cleaners or carts again. Generally, there are two reflectors used in the conventional laser distance measure, the first reflector reflects the laser beam toward the object, and the second reflect the laser beams bounced back from the object and toward the processing unit which calculates the distance that the cleaner and cart moves. The laser beams have to pass through the second reflector and moves toward the first reflector which guides the laser beams toward the object. This conventional laser beam path may cause the laser beams to have a slightly shift so that the distance measured is not precise.

One of the known laser distance measures uses a motor and a belt to rotate the whole distance measure unit. However, this requires a large case and is heavy so that the motor has to be a high power motor and also consumes a lot of power. Besides, how to provide power to a rotary unit and how to send data have a certain level of difficulty.

U.S. Pat. No. 8,305,561 uses two reflectors which are arranged to be perpendicular with each other, and are responsible for emitting laser beams and receiving the laser beams that is bounced back. The system is an off-axis system which cannot deal with the measure within a short distance. U.S. Pat. No. 7,589,826 uses a reflector that has a half area for reflection and half area for the laser beams to pass it through, and the emitting unit and the receiving unit are arranged to be co-axial. However, the reflector can only reflect 25% of the energy and the ability of distance measurement is reduced 50%.

The present invention intends to provide a laser distance measure which is focused on the laser beam path so as to eliminate the shortcomings mentioned above.

### SUMMARY OF THE INVENTION

The present invention relates to a laser beam path device received in a laser distance measure, and comprises a box having a receiving unit and a first reflector respectively in two ends of the box. The first reflector is inclinedly installed and has a hole defined centrally therethrough. The receiving unit controls displacement of the laser distance measure. A driving unit is located above the first reflector and has a second reflector received therein which is located corresponding to the first reflector. An opening is defined through the driving unit and located corresponding to the second reflector. A laser unit is connected to the box and emits laser beams which passes through the hole of the first reflector and is reflected by the second reflector, and the laser beams move toward an object. The laser beams are bounced back by the object and reflected first and second reflectors, and received by the receiving unit. The receiving unit processes the received laser beams so as to control the displacement of the laser distance measure.

Preferably, the box has a first room and a second room which communicates with the first room. The first reflector is located in the first room, and the receiving unit is located in the second room. The first reflector has a first reflection face which faces the second room.

Preferably, the driving unit has a motor, a cover and a belt. The cover has one end pivotably connected to the box and located above the first room. The cover has a third room defined therein which communicates with the opening and the first room. The second reflector is located in the third room and located corresponding to the first reflection face of the first reflector. A groove is defined around the outside of the cover. The motor has a driving shaft. The belt is engaged with the groove and driven by the driving shaft. The motor drives the driving shaft which rotates the belt, and the belt rotates the cover relative to the box. A board is connected to the box, and the motor is connected to the board.

Preferably, the driving unit has a motor and a cover, the cover has one end pivotably connected to the box and located above the first room. The cover has a third room defined therein which communicates with the opening and the first room. The second reflector is located in the third room and located corresponding to the first reflection face of the first reflector. The motor has a driving shaft which is pivotably connected to the cover. The motor drives the driving shaft which rotates the belt. The belt rotates the cover relative to the box. A frame has multiple legs which are connected to the box. The motor is connected to the underside of the frame.

Preferably, the driving unit has a motor and a cover, wherein the motor is located in the first room and above the first reflector. The motor has a case and a core which is rotatably located in the case. A passage is defined centrally through the core and located corresponding to the hole of the first reflector. The cover has one end pivotably connected to the core of the motor. The cover has a third room defined therein which communicates with the opening, the first room and the passage. The second reflector is located in the third room and located corresponding to the first reflection face of the first reflector. The laser beams passes through the hole of the first reflector and the passage of the core, and reaches the second reflector.

Preferably, a lens is located between the first reflector and the receiving unit. The receiving unit has at least one control unit which faces the lens. The first reflector reflects the laser beams from the laser unit and the laser beams moves toward the lens. The lens collects the laser beams which reaches the at least one control unit. The at least one control unit receives the laser beams and calculates the laser beams to control the displacement of the laser distance measure.

Preferably, reflection material is coated to the first reflection face of the first reflector and the face of the second reflector that faces the first reflection face.

Preferably, a tube extends through the hole of the first reflector. The laser beams from the laser unit passes through the tube and reaches the second reflector.

The present invention further provides another embodiment which comprises a box having a receiving unit located at the first end thereof, and a first reflector is received in the box and located at the second end of the box. The first reflector is inclined relative to the longitudinal axis of the box and has a hole defined centrally therethrough. The receiving unit controls the displacement of the laser distance measure.

A laser unit is connected to the box and emits laser beams toward the first reflector. The laser beams pass through the hole of the first reflector and moves toward the second reflector which reflects the laser beams which pass through the opening and toward an object to form the outgoing path. The laser beams are reflected by the object and reflected by the first reflector and toward to the receiving unit to form the incoming path. The receiving unit receives the laser beams and controls the displacement of the laser distance measure.

Preferably, the box has a first room and a second room which communicates with the first room. The first reflector is located in the first room. The receiving unit is located in the second room. The first reflector has a first reflection face which faces the second room. Reflection material is coated to the first reflection face of the first reflector.

Preferably, a lens is located between the first reflector and the receiving unit. The receiving unit has at least one control unit which faces the lens. The first reflector reflects the laser beams from the laser unit and the laser beams move toward the lens. The lens collects the laser beams and the laser beams reach the at least one control unit. The at least one control unit receives the laser beams and calculates the laser beams to control the displacement of the laser distance measure.

Preferably, a tube extends through the hole of the first reflector. The laser beams from the laser unit pass through the tube and reach the first reflector.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the laser beam path device of the present invention;

FIG. 2 is a cross sectional view to show the laser beam path device of the present invention;

FIG. 3 shows the outgoing path of the laser beams of the laser beam path device of the present invention;

FIG. 4 shows the incoming path of the laser beams of the laser beam path device of the present invention;

FIG. 5 shows the travel path of the laser beams when using the laser beam path device of the present invention;

FIG. 6 is a perspective view to show the second embodiment of the laser beam path device of the present invention;

FIG. 7 shows the third embodiment of the present invention, wherein each of the first and second reflectors has the reflection material coated thereon;

FIG. 8 shows a lens is used in the embodiment of the laser beam path device of the present invention;

FIG. 9 shows the laser beam path of the laser beam path device of the present invention as shown in FIG. 8;

FIG. 10 shows the cross sectional view of the third embodiment of the present invention, and

FIG. 11 shows the fourth embodiment of the present invention.

### DETAILED DESCRIPTION OF THE PREFERRED EMBODIMENT

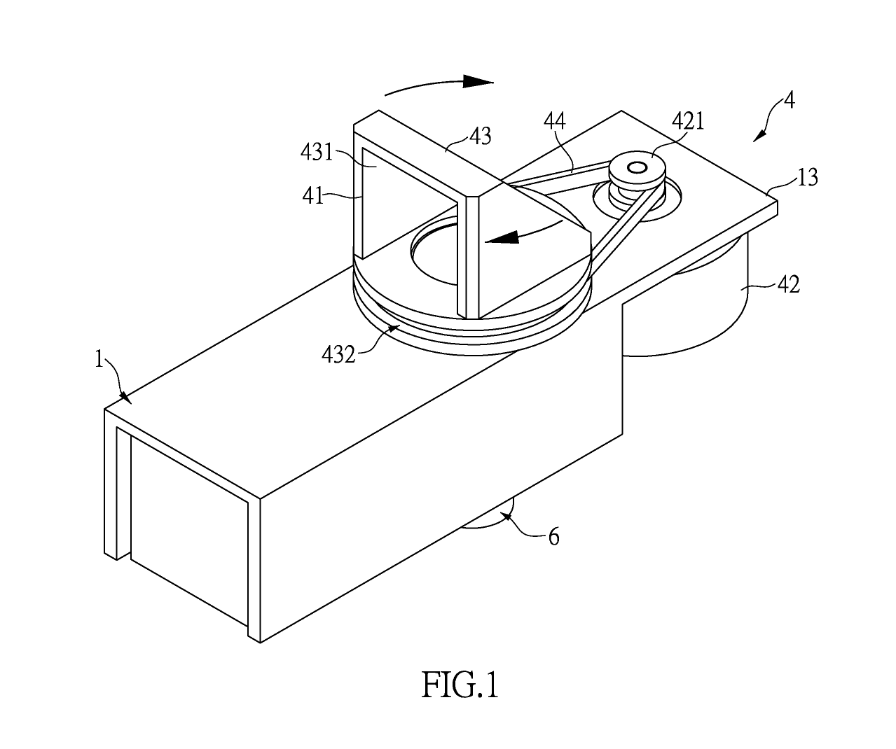

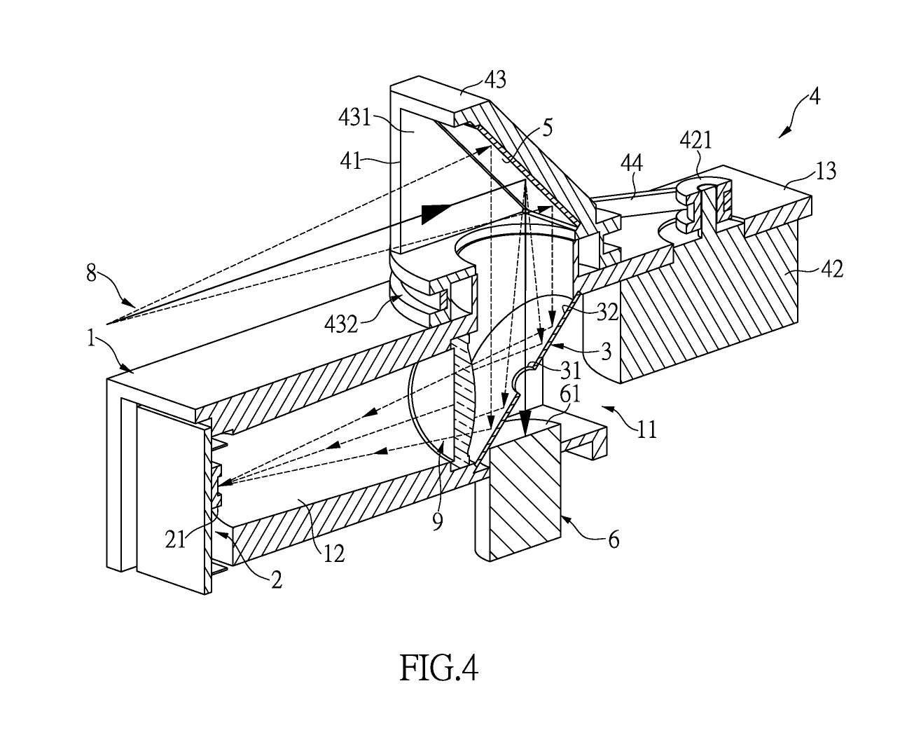

Referring to FIGS. 1 to 5, the laser beam path device received in a laser distance measure of the present invention comprises a box 1 having a receiving unit 2 located at the first end thereof, and a first reflector 3 is received in the box 1 and located at the second end of the box 1. The first reflector 3 is inclined relative to the longitudinal axis of the box 1 and has a hole 31 defined centrally therethrough. The receiving unit 2 controls displacement of the laser distance measure which is installed in a cart or a cleaner which is not shown.

A driving unit 4 is connected to the top of the box 1 and located above the first reflector 3. The driving unit 4 has a second reflector 5 which is located corresponding to the first reflector 3. An opening 41 is defined through the driving unit 4 and located corresponding to the second reflector 5. The driving unit 4 is rotatably relative to the box 1.

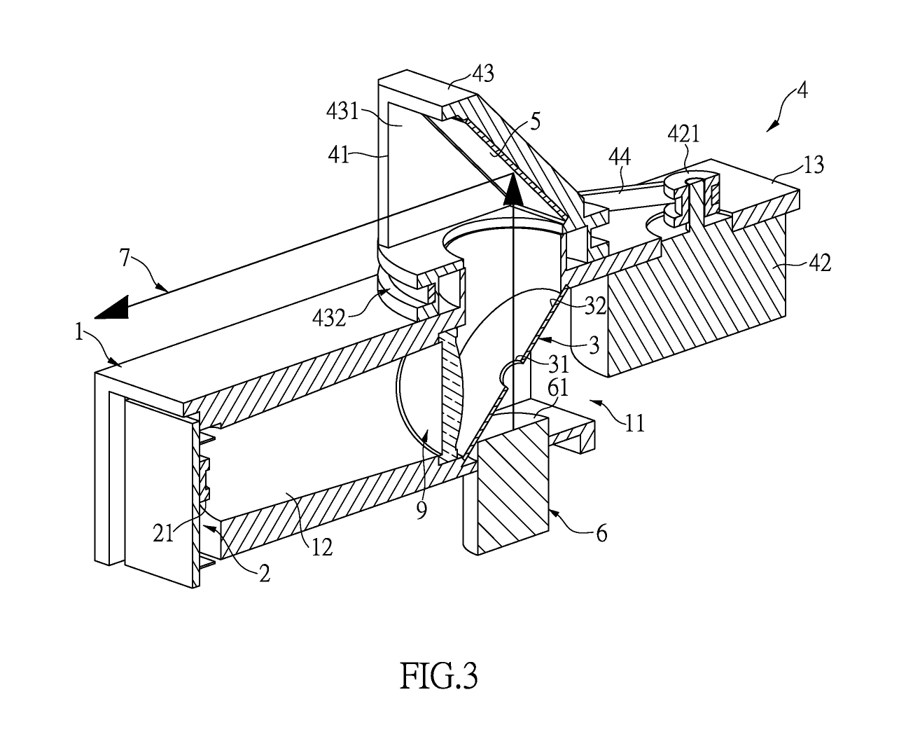

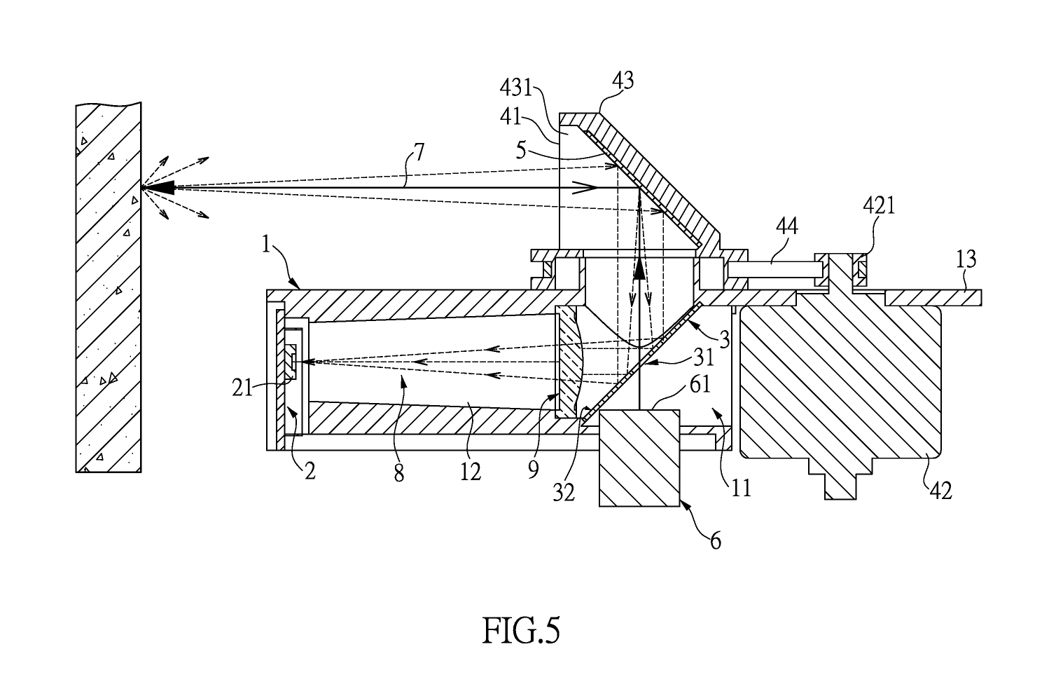

A laser unit 6 is connected to the underside of the box 1 and beneath the first reflector 3. The laser unit 6 emits laser beams which pass through the hole 31 of the first reflector 3 and moves toward the second reflector 5 which reflects the laser beams which then pass through the opening 41 and move toward an object to form an outgoing path 7. The laser beams are reflected by the object and reflected by the first reflector 3 and toward to the receiving unit 2 to form an incoming path 8. The receiving unit 2 receives the laser beams to further control the displacement of the laser distance measure. The laser beams can be visible and invisible for human, the invisible laser beams are shown by phantom lines in FIG. 5. When the receiving unit 2 receives the laser beams, the receiving unit 2 processes a series of calculation and judgement to control the precise displacement of the cart or the cleaner as shown in FIGS. 3 to 5.

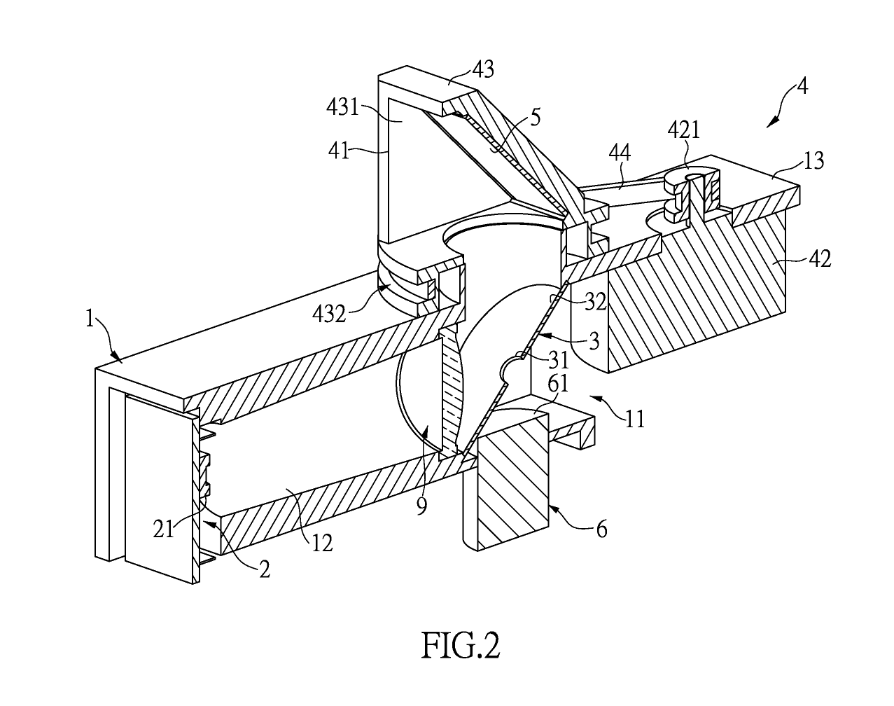

As shown in FIG. 2, the box 1 has a first room 11 and a second room 12 which communicates with the first room 11. The first reflector 3 is located in the first room 11, and the receiving unit 2 is located in the second room 12. The first reflector 3 has a first reflection face 32 which faces the second room 12. The laser beams are reflected by the first reflection face 32 and move toward to the second room 12. The receiving unit 2 located in the second room 12 receives the laser beams reflected from the first reflector 3. In other words, the laser unit 6 emits the laser beams to pass through the outgoing end 61 thereof and detects the object, the second reflector 5 reflects the laser beams toward the first reflection face 32 of the first reflector 3, the first reflection face 32 reflects the laser beams toward the receiving unit 2, so that the receiving unit 2 processes a series of calculation and judgement to control the precise displacement of the cart or the cleaner. A lens 9 is located in the second room 12 and between the first reflector 3 and the receiving unit 2. The lens 9 collects and concentrates the laser beams that are reflected by the first reflection face 32 so as to ensure that all of the laser beams of the incoming path 8 in the second room 12 are received by the receiving unit 2. The receiving unit 2 has at least one control unit 21 which faces the lens 9. The laser beams reach the at least one control unit 21. The at least one control unit 21 receives the laser beams and calculates the laser beams to control the displacement of the laser distance measure. The lens 9 is not necessarily installed in the second room 12. The number of the at least one control unit 21 changes according to the installation of the lens 9. When there is a lens 9, the number of the at least one control unit 21 can be only one. As shown in FIG. 2, when there is no lens 9, the number of the at least one control unit 21 must be plural so as to receive all of the laser beams reflected from the first reflector 3. No matter there is a lens 9 or there is no lens 9, the receiving unit 2 can precisely control the displacement of the cart or the cleaner.

The driving unit 4 has three different embodiments, the first embodiment of the driving unit 4 comprises a motor 42, a cover 43 and a belt 44. As shown in FIGS. 1 and 2, the cover 43 is a pyramid-shaped cover and has one end pivotably connected to the box 1 and located above the first room 11. The cover 43 has a third room 431 defined therein which communicates with the opening 41 and the first room 11. The laser beams coining from the first room 11 pass through the third room 431 and the opening 41. The second reflector 5 is located in the third room 431 and located corresponding to the first reflection face 32 of the first reflector 3. A groove 432 is defined around the outside of the cover 43. The motor 42 is located beside the box 1 and has a driving shaft 421. The belt 44 is engaged with the groove 432 and driven by the driving shaft 421. The motor 42 drives the driving shaft 421 which rotates the belt 44, and the belt 44 rotates the cover 43 relative to the box 1. The position of the opening 41 changes along with the rotation of the cover 43. Therefore, the laser beams passing through the opening 41 shoot within a range of 360 degrees. A board 13 is connected to the box 1, and the motor 42 is connected to the board 13.

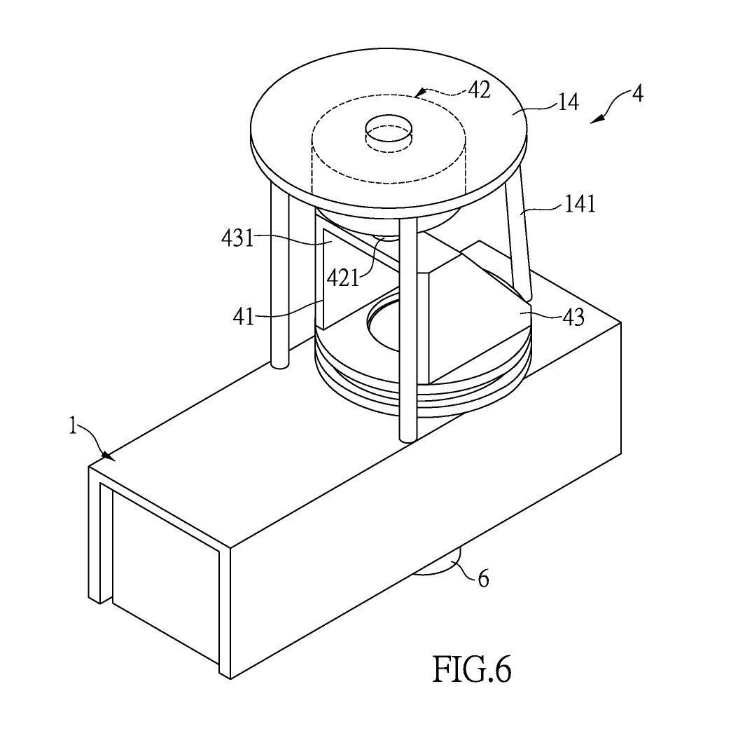

The second embodiment of the driving unit 4 comprises a motor 42 and a cover 43. The difference of the second embodiment from the first embodiment is that the second embodiment does not have the belt 44 as shown in FIG. 6. The cover 43 is rotatable relative to the box 1 by the rotation of the driving shaft 421. The motor 42 is connected to the top of the cover 43 so as to rotate the cover 43 to change the position of the opening 41. A frame 14 has multiple legs 141 which are connected to the box 1. The motor 42 is connected to the underside of the frame 14.

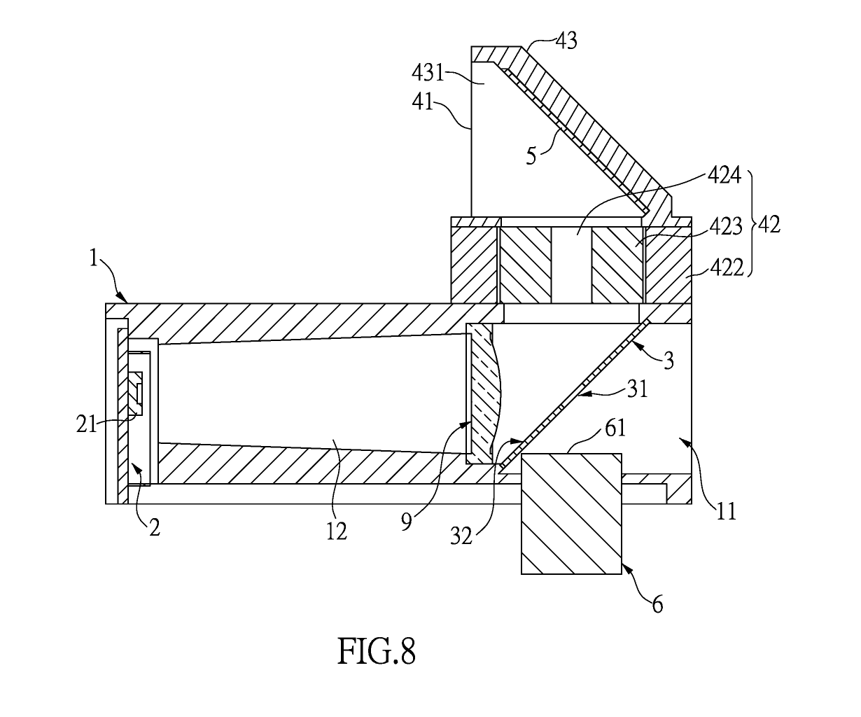

The third embodiment of the driving unit 4 is shown in FIG. 8. The difference of the third embodiment from the first and second embodiments is the design of the motor 42. As shown in FIG. 8, the motor 42 has a case 422 and a core 423 which is rotatably located in the case 422. A passage 424 is defined centrally through the core 423 and located corresponding to the hole 31 of the first reflector 3. The cover 43 has one end pivotably connected to the core 423 of the motor 42. The cover 43 has a third room 431 defined therein which communicates with the opening 41, the first room 11 and the passage 424. The second reflector 5 is located in the third room 431 and located corresponding to the first reflection face 32 of the first reflector 3. The laser beams pass through the hole 31 of the first reflector 3 and the passage 424 of the core 423, and reach the second reflector 5. All of the three embodiments can rotate the cover 43 to assist the laser distance measure to move in different directions.

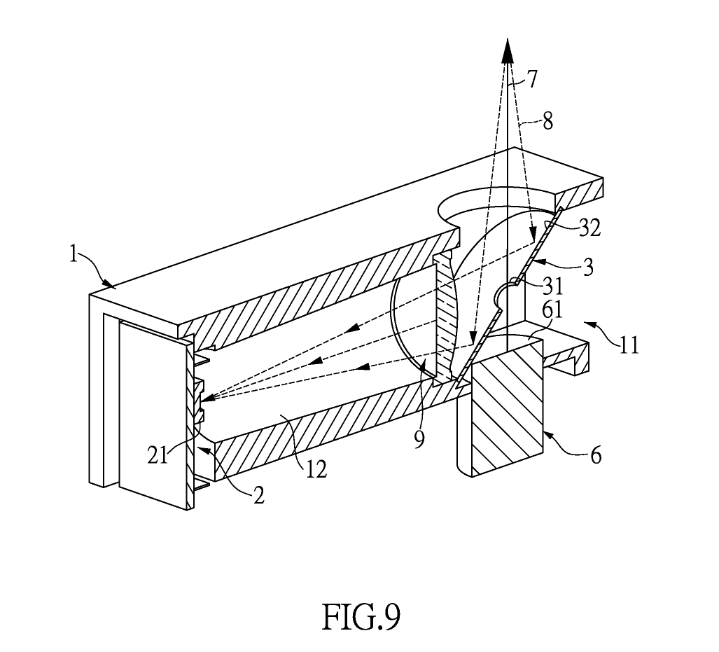

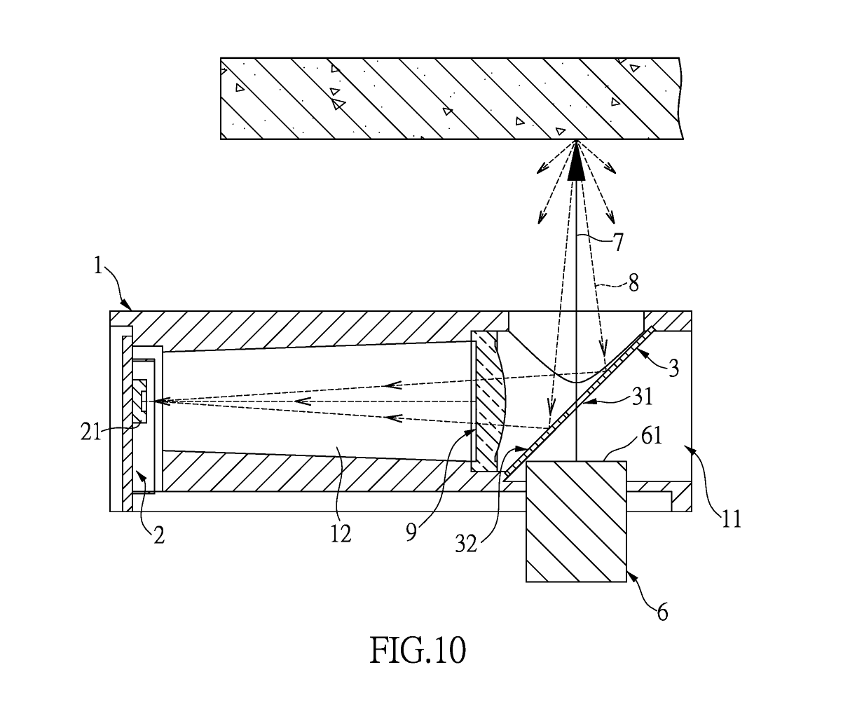

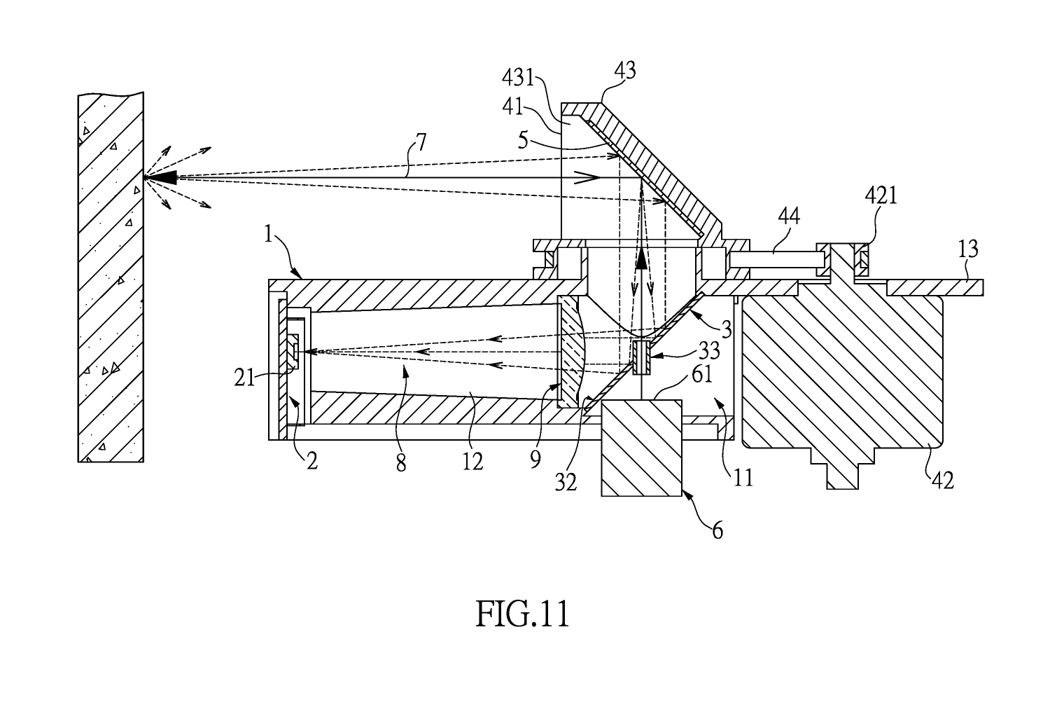

FIGS. 9 and 10 show yet another embodiment wherein the difference of the embodiment in FIGS. 9 and 10 from the above mentioned embodiments is that there is no driving unit 4. The box 1 is installed upward to the cart or the cleaner. As shown in FIG. 10, the laser beams pass through the outgoing end 61 of the laser unit 6 and pass through the hole 31 of the first reflector 3, the laser beams directly reach the object. The laser beams are then reflected by the object and reach the first reflection face 32 and move toward the receiving unit 2. The receiving unit 2 receives the laser beams to calculate and make judgement to control the displacement of the laser distance measure. FIG. 11 further discloses another embodiment, wherein a tube 33 extends through the hole 31 of the first reflector 3. The laser beams from the laser unit 6 pass through the tube 33 and reach the second reflector 5. The tube 33 further concentrates the laser beams and avoids other light source from entering the lens 9.

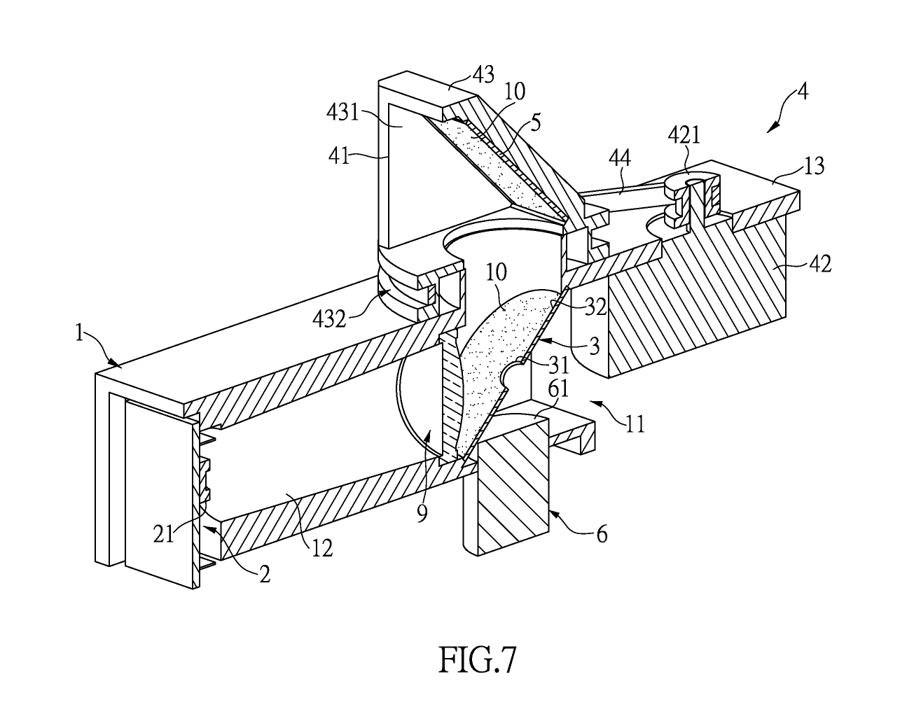

The reflection material 10 is coated to the first reflection face 32 of the first reflector 3 and the face of the second reflector 5 that faces the first reflection face 32. This ensures that the laser beams, either in the outgoing path 7 or the incoming path 8 as shown in FIGS. 5 and 7, do not shift so that the laser beams precisely reach to the at least one control unit 21.

The hole 31 of the first reflector 3 ensures the laser beams not to shift at the first place. Therefore, the laser beams bounce back from the object and are reflected by the second reflector 5 and the first reflection face 32 of the first reflector 3, and then are received by the receiving unit 2. Besides, the driving unit 4 allows the laser distance measure to detect 360 degrees around the laser distance measure.

While we have shown and described the embodiment in accordance with the present invention, it should be clear to those skilled in the art that further embodiments may be made without departing from the scope of the present invention.

What is claimed is:

1. A laser beam path device received in a laser distance measure, comprising:
a box having a receiving unit located at a first end thereof, a first reflector received in the box and located at a second end of the box, the first reflector being inclined relative to a longitudinal axis of the box and having a hole defined centrally therethrough, the receiving unit adapted to control displacement of the laser distance measure;
a driving unit connected to a top of the box and located above the first reflector, the driving unit having a second reflector which is located corresponding to the first reflector, an opening defined through the driving unit and located corresponding to the second reflector, the driving unit being rotatably relative to the box, and
a laser unit connected to the box and emitting laser beams toward the first reflector, the laser beams passing through the hole of the first reflector and moving toward the second reflector which reflects the laser beams which then pass through the opening and toward an object to form an outgoing path, the laser beams being reflected by the object and reflected by the first reflector and toward to the receiving unit to form an incoming path, the receiving unit receiving the laser beams and adapted to control the displacement of the laser distance measure.

2. The laser beam path device as claimed in claim 1, wherein the box has a first room and a second room which communicates with the first room, the first reflector is located in the first room, the receiving unit is located in the second room, the first reflector has a first reflection face 32 which faces the second room.

3. The laser beam path device as claimed in claim 2, wherein the driving unit has a motor, a cover and a belt, the cover has one end pivotably connected to the box and located above the first room, the cover has a third room defined therein which communicates with the opening and the first room, the second reflector is located in the third room and located corresponding to the first reflection face of the first reflector, a groove is defined around an outside of the cover, the motor has a driving shaft, the belt is engaged with the groove and driven by the driving shaft, the motor drives the driving shaft which rotates the belt, the belt rotates the cover relative to the box, a board is connected to the box, the motor is connected to the board.

4. The laser beam path device as claimed in claim 2, wherein the driving unit has a motor and a cover, the cover has one end pivotably connected to the box and located above the first room, the cover has a third room defined therein which communicates with the opening and the first room, the second reflector is located in the third room and located corresponding to the first reflection face of the first reflector, the motor has a driving shaft which is pivotably connected to the cover, the motor drives the driving shaft which rotates the belt, the belt rotates the cover relative to the box, a frame has multiple legs which are connected to the box, the motor is connected to an underside of the frame.

5. The laser beam path device as claimed in claim 2, wherein the driving unit has a motor and a cover, the motor is located in the first room and above the first reflector, the motor has a case and a core which is rotatably located in the case, a passage is defined centrally through the core and located corresponding to the hole of the first reflector, the cover has one end pivotably connected to the core of the motor, the cover has a third room defined therein which communicates with the opening, the first room and the passage, the second reflector is located in the third room and located corresponding to the first reflection face of the first reflector, the laser beams pass through the hole of the first reflector and the passage of the core, and reach the second reflector.

6. The laser beam path device as claimed in claim 1, wherein a lens is located between the first reflector and the receiving unit, the receiving unit has at least one control unit which faces the lens, the first reflector reflects the laser beams from the laser unit and the laser beams move toward the lens, the lens collects the laser beams which reach the at least one control unit, the at least one control unit receives the laser beams and calculates the laser beams to be adapted to control the displacement of the laser distance measure.

7. The laser beam path device as claimed in claim 6, wherein reflection material is coated to the first reflection face of the first reflector and the face of the second reflector that faces the first reflection face.

8. The laser beam path device as claimed in claim 6, wherein a tube extends through the hole of the first reflector, the laser beams from the laser unit pass through the tube and reach the second reflector.

9. A laser beam path device received in a laser distance measure, comprising:
a box having a receiving unit located at a first end thereof, a first reflector received in the box and located at a second end of the box, the first reflector being inclined relative to a longitudinal axis of the box and having a hole defined centrally therethrough, the receiving unit adapted to control displacement of the laser distance measure, and
a laser unit connected to the box and emitting laser beams toward the first reflector, the laser beams passing through the hole of the first reflector and moving toward the second reflector which reflects the laser beams which pass through the opening and toward an object to form an outgoing path, the laser beams being reflected by the object and reflected by the first reflector and toward to the receiving unit to form an incoming path, the receiving unit receiving the laser beams and adapted to control the displacement of the laser distance measure.

10. The laser beam path device as claimed in claim 9, wherein the box has a first room and a second room which communicates with the first room, the first reflector is located in the first room, the receiving unit is located in the second room, the first reflector has a first reflection face which faces the second room, reflection material is coated to the first reflection face of the first reflector.

11. The laser beam path device as claimed in claim 9, wherein a lens is located between the first reflector and the receiving unit, the receiving unit has at least one control unit which faces the lens, the first reflector reflects the laser beams from the laser unit and the laser beams move toward the lens, the lens collects the laser beams and the laser beams reach the at least one control unit, the at least one control unit receives the laser beams and calculates the laser beams to be adapted to control the displacement of the laser distance measure.

12. The laser beam path device as claimed in claim 11, wherein a tube extends through the hole of the first reflector, the laser beams from the laser unit pass through the tube and reach the first reflector.
